(19) United States
(12) Patent Application Publication
(10) Pub. No.: US 2009/0164339 A1
(43) Pub. Date: Jun. 25, 2009

(54) 3D PRODUCT DISPLAY ON INTERNET WITH CONTENT OR TRANSACTION DATA ON BACK OF IMAGE

(75) Inventor: Simon Rothman, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Glyde Corporation, Palo Alto, CA (US)

(21) Appl. No.: 11/963,718

(22) Filed: Dec. 21, 2007

(51) Int. Cl. G06Q 30/00

(52) U.S. Cl. 705/27

(57) ABSTRACT

A three dimensional use of an area to provide information. When a user clicks on cover art, for example, the art is replaced with descriptive material in the same space, as if the book or DVD were flipped over (but not a literal showing of the backside of the physical product). The flip side shows either (1) content data, (2) transaction data, or (3) community data. For example, content data can be select songs for a CD or chapters for a book. Transaction data can show a market price, or, for a seller, whether a product has been sold. Community data can be how popular the product is, such as how many other people have bought it.

### CROSS-REFERENCES TO RELATED APPLICATIONS

Related applications are Ser. No. ______, “Virtual Shelf with Single Product Choice and Automatic Multiple Vendor Selection” [Attorney Docket no. 027050-000100US]; Ser. No. ______, entitled “System and Method for Dynamic Product Pricing” [Attorney Docket No.: 027050-000200US]; Ser. No. ______, “Software System for Decentralizing eCommerce with Single Page Buy,” [Attorney Docket No.: 027050-000300US]; Ser. No. ______,“Product Distribution System and Method Thereof” [Attorney Docket No.: 027050-000500US]; Ser. No. ______, “System and Method for Providing Real-Time Search Results on Merchandise,” [Attorney Docket No.: 027050-000600US]; Ser. No. ______, “System and Method for Integrated Payment and Shipping Information,” [Attorney Docket No.: 027050-000700US]; all filed even date herewith.

### BACKGROUND OF THE INVENTION

The present invention relates to changing an ad or image appearance in response to user action, and in particular to providing a 3D quality to the ad by flipping it over to reveal a back side.

When websites display information, it is typically two-dimensional. Cover art may be displayed for a book or DVD, for example. More information about it is then in text below or around the artwork. Alternately, graphic information can be displayed, and when a cursor is moved over it, a bubble with more data will appear to the side or above the graphic.

US Patent Application Publication No. 20020113815 describes images forming a cover or door, that is placed over internet ads. When the ad door image is selected, it disappears in the manner of a door opening, or another uncovering manner, to reveal the advertising contents beneath and explode into a larger space if needed. The idea is to get the user curious by showing nothing but a door, with the user having to take action to see advertising content.

U.S. Pat. No. 7,111,252 shows three-dimensional representations of products being sold over the Internet. For example, an aspirin bottle may be shown, with the user being able to rotate the bottle using movement keys. The bottle can be rotated, for example, to show an ingredient label on the back.

### BRIEF SUMMARY OF THE INVENTION

The present invention provides a 3 dimensional use of an area to provide information. When a user clicks on an image or representation (e.g., cover art for a book or DVD), for example, the art is replaced with descriptive material in the same space, as if the book or DVD were flipped over (but not a literal showing of the backside of the physical product). In one embodiment, the display shows the art being turned over, like a slide transition (e.g., PowerPoint presentation software).

In one embodiment, the image is “flipped” by a user clicking on it, or moving a cursor over it. The flip side shows either (1) content data, (2) transaction data, or (3) community data. For example, content data can be select songs for a CD or chapters for a book. Transaction data can show a market price, or, for a seller, whether a product has been sold. Community data can be how popular the product is, such as how many other people have bought it.

The image flipped over may relate to a product or service simply displayed, but not necessarily for sale. The type of information provided on the “back” can be varied depending upon who is looking at it. The system can tell who is looking at it by whether, for example, it is in a listing of products for sale (presumed buyer looking) or on a seller's inventory list of products (seller looking).

### BRIEF DESCRIPTION OF THE DRAWINGS

FIG. 1 is a diagram illustrating a single-page buy window according to an embodiment of the invention.

FIG. 2 is a diagram of an overall system supporting the present invention.

### DETAILED DESCRIPTION OF THE INVENTION

### Flip of Image

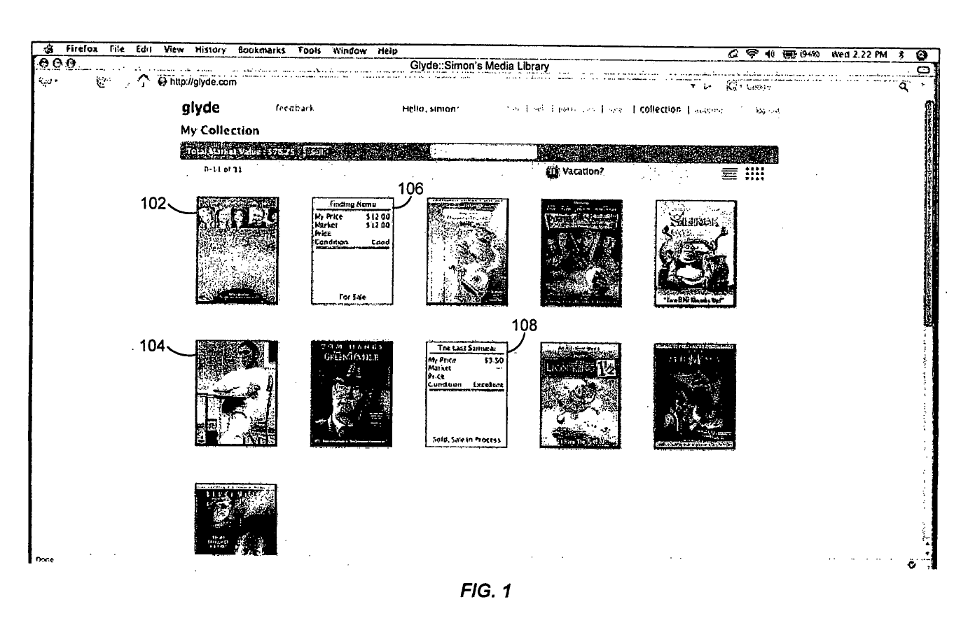

FIG. 1 illustrates a display of a seller's inventory according to an embodiment of the invention. In this example, the seller is an individual selling products or services (in this example, DVDs) on a multi-seller website. The display shows cover art for a collection of 12 DVDs being sold. The DVDs are normally displayed with an image of the cover art, as for DVDs 102 and 104. Upon the seller clicking on DVDs 106 and 108, the image is replaced with sales data. In this example, the sales data is the price it is being sold at, the market price, its condition (good, excellent), and the status (for sale, sold, sale in process). If multiple copies of the same DVD are being sold, the number sold can be presented behind the same image. Functionality can be added to the information displays. For example, by clicking on the market price, the seller can change the seller's price to the market price. Note that the seller can also list or catalog other products the seller has, without putting them up for sale. Thus, a tracking mechanism is provided. The back side of such products not for sale can simply designate “not listed for sale,” and a date the image was posted, for example.

In another embodiment, the products or services (e.g., DVDs) are displayed to potential buyers. The flip side of the DVD image may contain some of the same information, such as the sales price and condition. In addition, or instead, the flip side can provide information about the contents, such as the rating of the DVD, its length, the actors and director and a brief summary. For a CD, the flip side may contain a listing of a subset of the songs. Listing all of the songs is typically not possible in a small ad space. If the song title is clicked on, a sample of the song is played.

In one embodiment, a buyer page is shown displaying items purchased by the buyer. Where a user both buys and sells, this could be a section of a page that also lists items for sale from that user, or it could be a separate page. The listing could be all products historically bought, or the display could initially just show items bought but not delivered yet. The flip side of such items displays (1) the price paid, (2) the date purchased, (3) the estimated arrival time, and (4) the delivery status.

The system usually knows from what page is being viewed whether the viewer is a seller or a buyer, or whether the user is on a page or section of a page for sold or bought items. If it is an inventory page or section, it is a seller viewing. If it is a list of products for sale, it is assumed to be a buyer viewing. Thus, the information presented on the backside of the image depends on who is clicking or in what capacity the user is clicking.

The flipping of the cover art image may be accomplished in number of ways. The image can simply be replaced, or it can be shown as flipping, fading to the backside information, or any number of other transitions. For example, any of the transitions between slides available in presentation software may be used. The initiation of the flipping may be in response to a mouse click on the image, a double click or a right click. Alternately, simply moving the cursor over the image may cause it to flip. In another example, a webcam with eye tracking software could flip the image the user is detected looking at, if the user's gaze rests on the image for more than a couple seconds.

The flip side can be shown for any product or service being sold, not just DVDs or CDs. An image of an electronic device may have a flip side with basic product information. A camera for sale, for example, may list an image pixel size, amount of zoom, size and weight, and warranty length. A babysitting service may include the babysitter's qualifications and hourly rate.

In one embodiment, a third option is presented to the user, of seeing the actual backside (or other side, such as the spine of a book) upon a double click or other action by the user. Thus, in the same space, the user can see (1) the original image, (2) pertinent information (depending upon product type and user status as seller or buyer), or (3) the actual back or other view of the product.

In one embodiment, certain images may be pre-flipped over. For example, products already purchased by a user may be pre-flipped. There may be an “accept” icon on the flip side for a period of two days, or other time-out period, to prompt the user to accept the product condition. Alternately, items may be randomly flipped by the system to give a visual cue to the user that the items can be flipped. This might be done for the first five times the user views the display, or until the user executes a flip.

### Implementation of Flip of Image

In one embodiment, the data on the flip side of the image is provided using a Comet software program or similar technology. Comet enables web servers to send data to the browser without the need by the browser to continually re-request it. It allows creation of event-driven web applications, enabling real-time interaction in a browser. An open connection is established by the browser to the server allowing the server to update data on the client in real time. When a buyer clicks on an ad or image, the flip side information which was fetched by or pushed to the browser is displayed. Alternately, the flipping can be activated by a cursor passing over the image or representation, by detecting a user gazing at the image (through a camera with eye recognition and tracking software), or otherwise.

The software knows whether the user is a seller or potential buyer, and provides different flip side information depending on the user identity. The seller can log into the seller's personal web page on the multi-seller server, and thus the system knows the information is for a seller, and displays seller information. Similarly, a buyer may log into a personal web page of products bought and see an image display. Flipping the images will provide status data, such as whether the product has been shipped yet and its tracking number. Functionality can be added to this information as well. For example, clicking on the tracking number can bring up a tracking page with more details. Clicking on shipped date may show the anticipated delivery date, or other information about the order.

If the image is an ad and the user is not known to be a seller, the user is presumed to be a potential buyer, and buyer information is provided. In one embodiment, the best market price for the potential buyer is calculated and displayed when the ad is flipped. The price information includes the shipping costs. The shipping cost is calculated based on the dimensions and weight of the product, the address of the seller, and the address of the buyer. Because both seller and buyer information is stored, it is available at the time the user clicks on the product, and the calculation is run before the image is flipped. If the image is on the system server, a local database can be used. If the image is an ad on a 3rd party database, the information is pushed or fetched over the Internet to the window.

In one embodiment, the product is offered by multiple sellers. The price information is calculated by first selecting the appropriate seller using a number of factors, including seller reliability (rating, reputation, etc.), product price and seller shipping speed and cost based on postal proximity to the user, to select a seller with low shipping costs and high reliability. The price reflects the selection of the appropriate seller. In one embodiment, an actual seller is not picked until a buyer makes a buy decision. The software merely determines that there are one or more sellers who can supply the product at the price and shipping costs displayed. For a description of market price, see co-owned application Ser. No. ______, filed even date herewith, entitled “System and Method for Dynamic Product Pricing” [Attorney Docket No.: 027050-000200US], the disclosure of which is hereby incorporated herein by reference.

### System

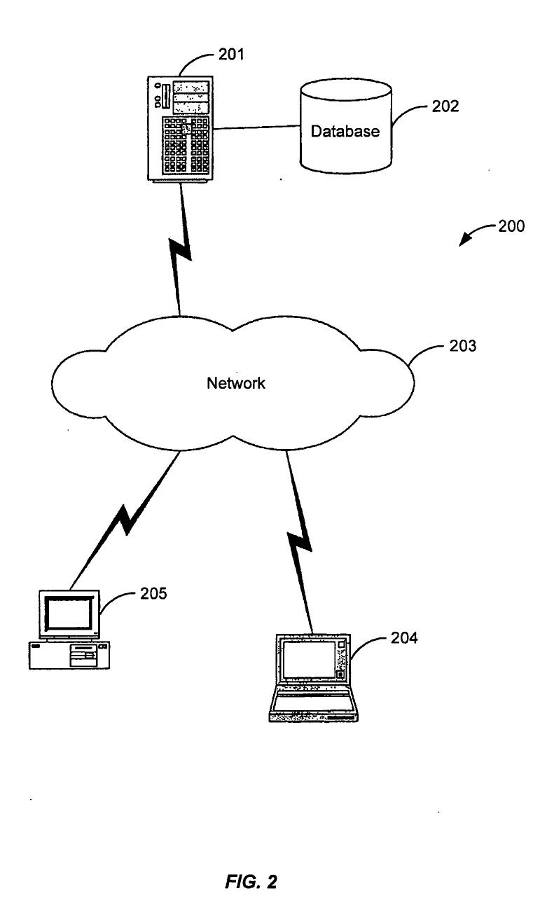

FIG. 2 illustrates a system supporting the present invention. A server 201 hosting the multi-seller website is connected to a network 203 (e.g., the Internet). Also connected to the Internet is a 3rd party seller 204 which may display ads for products on the multi-seller website. Finally, a user computer 205 is shown connected to the Internet, for browsing either the multi-seller or 3rd party website.

The server 201 is configured to provide the display of FIG. 1, and react to user actions. The server 201 may be implemented using multiple computing devices. A database 202 stores data on both sellers and users. In one embodiment, database 202 is directly connected to server 201. In another embodiment, database 202 includes multiple storage devices that are accessible over network 203 or another network.

It is to be understood that the examples and embodiments described above are for illustrative purposes only and that various modifications or changes in light thereof will be suggested to persons skilled in the art and are to be included within the spirit and purview of this application and scope of the appended claims. For example, clicking on a CD image could initiate playing a sample of a song, with the song title and a slider bar showing progress through the playing being displayed as the flip side of the image. For another example, the products can be DVDs, CDs, video games, books, consumer electronics (i.e., PDAs, cell phones, etc.), jewelry, toys, software or any other product or service. As used in the claims, the term “product” includes a service. In addition, the displayed “image” of the claims could include text or be solely text. Also, instead of being sold, the product could be rented, bartered, or subject to any other commerce transaction. Instead of individuals on a multi-seller website, the system can be used by large or small businesses or other groups, and the images could be displayed on any other internet site or other electronic media, including in a blog, an RSS feed, a text or media message for mobile phones, a TV ad that can be clicked with a remote, etc. Finally, instead of clicking to reverse an image, a cursor could just be paused on the image for a second or other measure of time. Therefore, the above description should not be understood as limiting the scope of the invention as defined by the claims.

What is claimed is:

1. A method for displaying information about products for sale, comprising:
displaying a representation of a product;
replacing said representation, in the same space as said representation, with product information responsive to action by a user with respect to said representation;
wherein said product information is descriptive information relating to a product other than a literal showing of the backside of a physical product.

2. The method of claim 1 wherein said product information is one of (a) content data, (b) transaction data, and (c) community data.

3. The method of claim 2 wherein said product is a CD and said content data is sample songs for said CD.

4. The method of claim 2 wherein said transaction data includes a best market price for said user.

5. The method of claim 2 wherein said community data includes how many other people have bought said product.

6. The method of claim 1 wherein said action by said user is a clicking on said representation.

7. The method of claim 1 further comprising:
determining whether said user is a seller or a potential buyer; and
displaying different information for said product information depending upon whether said user is a seller or a potential buyer.

8. The method of claim 1 further comprising:
detecting a user click on said descriptive information; and
performing a designated action in response to said user click.

9. The method of claim 8 wherein said descriptive information is a title of one of a song and a video, and said designated action is playing a sample of one of said song and said video.

10. The method of claim 1 wherein said product is a service.

11. The method of claim 1 wherein said image is text.

12. A computer-implemented system comprising:
a database configured to store product information for a product to be displayed over the internet;
a server configured to generate representations of products using data from said database;
a communication interface configured to provide a link between said server and a browser of a user; and
computer readable media including computer readable code for a software application comprising:
code for displaying said representations;
code for detecting a user action related to a selected one of said representations; and
code for replacing said representation, in the same space as said representation, with product information responsive to said user action;
wherein said product information is descriptive information relating to a product other than a literal showing of the backside of a physical product.

13. The system of claim 10 wherein said product information is one of (a) content data, (b) transaction data, and (c) community data.

14. The system of claim 11 wherein said product is a CD and said content data is sample songs for said CD.

15. The system of claim 11 wherein said transaction data includes a best market price for said user.

16. The system of claim 11 wherein said community data includes how many other people have bought said product.

17. The system of claim 10 further comprising:
code for determining whether said user is a seller or a potential buyer; and
code for displaying different information for said product information depending upon whether said user is a seller or a potential buyer.

18. The system of claim 10 further comprising:
code for detecting a user click on said descriptive information; and
code for performing a designated action in response to said user click.
